(19) United States
(12) Patent Application Publication
(10) Pub. No.: US 2002/0157291 A1
(43) Pub. Date: Oct. 31, 2002

(54) Advertisement display device

(76) Inventor: Chung-Kuei Lin, Hsinchuang City (TW)

Correspondence Address: ABELMAN FRAYNE & SCHWAB, Attorneys at Law, 150 East 42nd Street, New York, NY, 10017, US

(21) Appl. No.: 09/843,180

(22) Filed: Apr. 26, 2001

(51) Int. Cl. G09F 11/02

(52) U.S. Cl. 40/505; 40/503

(57) ABSTRACT

An advertisement display device mainly made up a housing having an upper chamber and a lower chamber, a motor disposed in the upper chamber, multiple gears disposed in a bottom of the lower chamber, and multiple three-face hollow columns positioned in the lower chamber and rotatably connected with the multiple gears and the motor. The motor is actuated to drive the multiple three-face hollow columns to rotate, and when each column has rotated 120 degrees the motor and the columns then stop, and an advertisement display area is formed to demonstrate advertising for a short period until the motor is actuated again whereafter a different advertisement is displayed.

### BACKGROUND OF THE INVENTION

1. Field of the Invention

The present invention relates to an advertisement display device, and more particularly to an advertisement display device that is mainly made up of a plurality of three-face hollow columns to form a display area that regularly demonstrates three different fascinating advertisements thereon.

2. Description of Related Art

A conventional advertisement display board is mainly composed of two plates (whereon the advertising words or figures are displayed) to form a chamber so as to sandwich several light tubes in the chamber. When the light tubes are turned on, the light passes through the two plates, thus the advertising words or figures positioned on the two plates become very eye-catching. However, on the conventional advertisement display board, only one fixed set of advertisement can be displayed on the board. The lack of advertisement variation makes the display board too simple and even boring. Furthermore, if more display boards are required to display different advertisements, the display boards will occupy a lot of space and make the limited space in a business site inadequate

To overcome the shortcomings, the present invention tends to provide an advertisement display device to mitigate and obviate the aforementioned problems.

### SUMMARY OF THE INVENTION

The main objective of the invention tends to provide an advertisement display device to demonstrate three different kinds of advertisements and further provide an accompaniment of decorative music to the advertisements to enhance a publicizing effect.

The second objective of the invention tends to provide an advertisement display device to avoid excessive space being occupied.

Other objects, advantages and novel features of the invention will become more apparent from the following detailed description when taken in conjunction with the accompanying drawings.

### BRIEF DESCRIPTION OF THE DRAWINGS

FIG. 1 is a front view of an advertisement display device in accordance with the present invention;

FIG. 2 is a cross-sectional view of the advertisement display device of the present invention taking along 2-2 shown in FIG. 1;

FIG. 3 is a rear view of the advertisement display device with a part of a rear cover removed, in accordance with the present invention;

FIG. 4 is a perspective view of a motor of the advertisement display device of FIG. 1; and

FIG. 5 is an exploded view of a three-face hollow column of the advertisement display device of FIG. 1.

### DETAILED DESCRIPTION OF THE PREFERRED EMBODIMENT

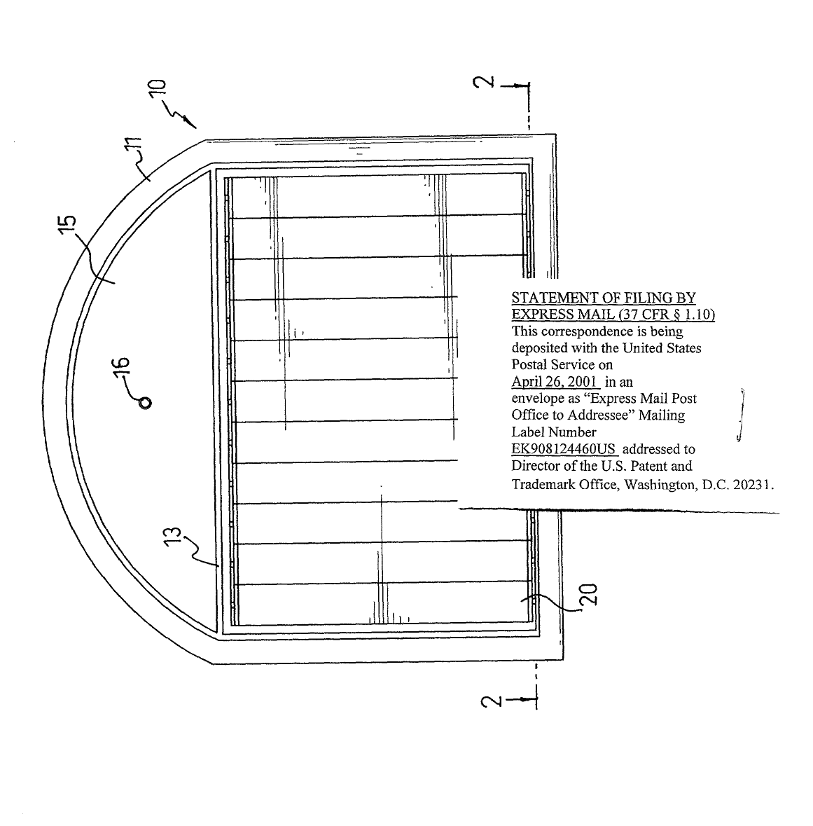

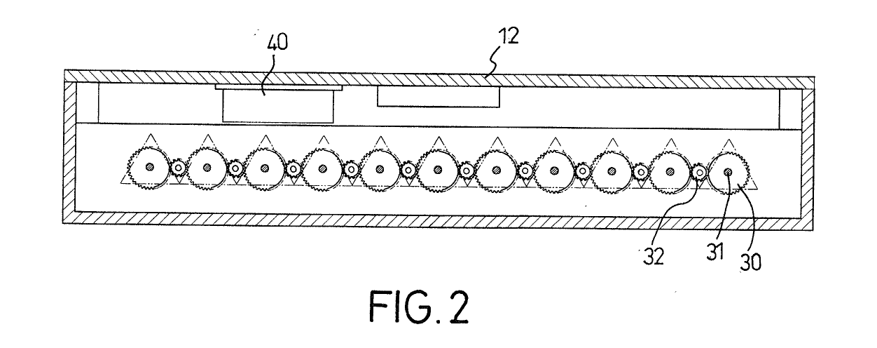

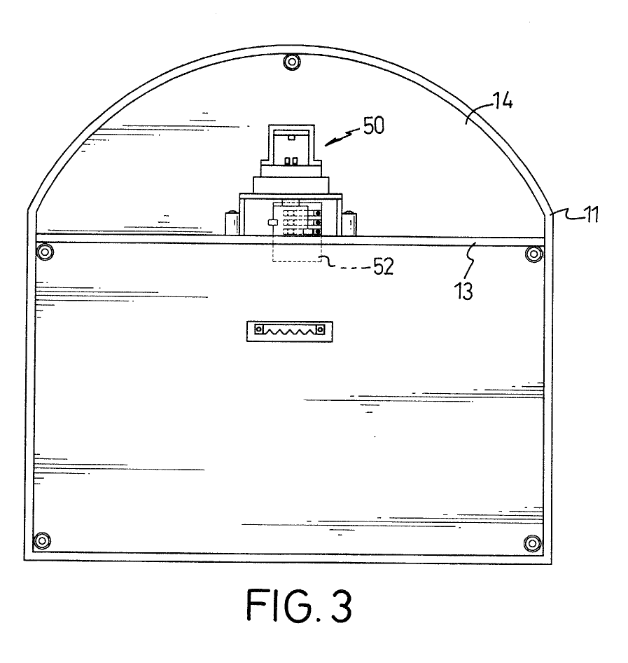

With reference to FIGS. 1 and 2, an advertisement display device of the present invention mainly comprises a housing (10) and multiple three-face hollow columns (20). The housing (10) is made up of a frame (11) with a cambered shape top, and a rear cover (12) positioned at and covering a rear of the frame (11). A partition plate (13) is provided in the frame (11) to partition it into an upper chamber (14) (shown in FIG. 3) and a lower chamber. The three-face hollow columns (20) each comprise a respective portion of three complete advertisements.

A front of the upper chamber (14) is covered with a cambered board (15) that is arranged with an optical transmitter (16) in a central portion to regularly transmit a light signal to an optical sensor. The optical sensor is positioned in the upper chamber (14) and in alignment with the optical transmitter (16) to receive the light signal.

Multiple first gears (30) are rotatably positioned on a bottom of the frame (11), wherein each first gear (30) is defined with a hole (31) at its center. Between each two adjacent first gears (30), there is provided a second gear (32).

FIG. 3 shows a part of the rear cover (12) is taken off to reveal the rear view of the upper chamber (14). In the upper chamber (14), a motor (50) is disposed on the partition plate (13), wherein an axle of the motor (50) downwardly extends through the partition plate (13). The motor (50) is arranged to be actuable by the optical sensor.

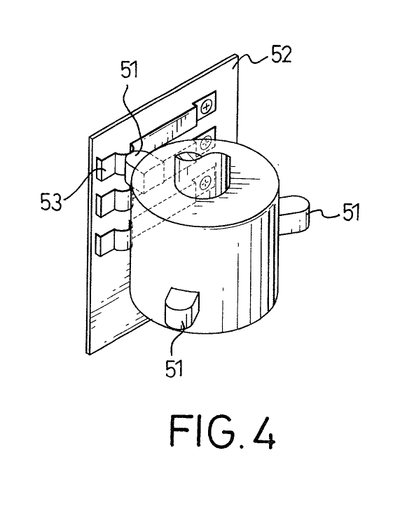

With reference to FIG. 4, an upper portion of the axle of the motor (50) is formed with three pegs (51) equi-distantly disposed around the axle, and respectively distributed at three heights with equal intervals.

With reference to FIGS. 2 and 4, the rear cover (12) has a battery (40) securely disposed thereon for providing a power supply, a circuit board (not shown) electrically connected with the battery (40), the motor (50), the optical sensor and a speaker (not shown). Furthermore, a trigger plate (52) is disposed on the rear cover (12) and connected with the circuit board, wherein the trigger plate (52) has three trigger members (53) arranged at three heights relative to the heights of the pegs (51).

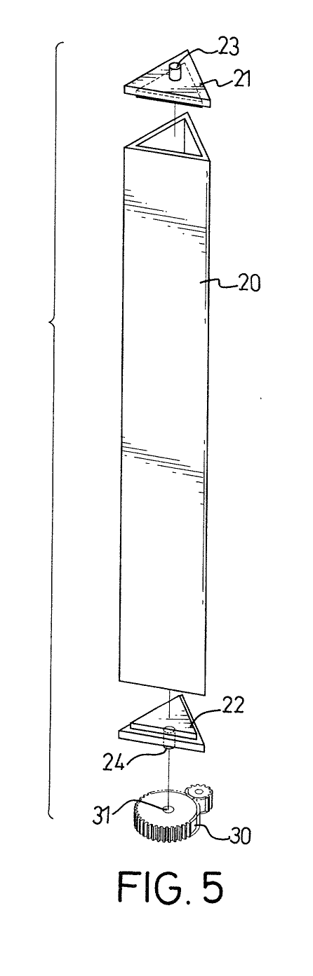

With reference to FIG. 5, each of the multiple three-face hollow columns (20) has a top cover (21) and a bottom cover (22) to securely cover two ends of each column (20). The top cover (21) and the bottom cover (22) are respectively formed with a first stub (23) and a second stub (24). Each first stub (23) is rotatably installed in the partition plate (13), and the first stub (23) of one of the multiple three-face hollow columns (20) is connected with the axle of the motor (50). Each second stub (24) corresponds to the hole (31) of each first gear (30), so that when each second stub (24) securely inserts into the respective hole (31), each first gear (30) drives the respective column (20) to rotate.

In a first phase when the motor (50) is not actuated, the columns (20) are aligned to show a first advertisement formed by the multiple portions disposed on a respective one of the three-face of each column (20). When the motor (50) is actuated by the optical sensor, the axle of the motor (50) drives one of the multiple three-face hollow columns (20) to rotate in a second phase, whereby each first gear (30) simultaneously starts to rotate so as to drive the other three-face hollow columns (20). After each three-face hollow column (20) rotates 120 degrees, one of the pegs (51) on the axle contacts with the corresponding trigger member (53) of the trigger plate (51). Then each three-face hollow column (20) stops rotating for a short period of time and another complete advertisement is formed. Meanwhile, the circuit board controls the speaker to output music. When the speaker stops outputting music, the optical transmitter emits the light signal to the optical sensor so as to control the motor (50) to actuate again. By repeating the sequence of foregoing action, the advertisement display device is able to be sequentially demonstrate three different kinds of advertisements.

Although the present invention has been explained in relation to its preferred embodiment, it is to be understood that many other possible modifications and variations can be made without departing from the spirit and scope of the invention as hereinafter claimed.

What is claimed is:

1. An advertisement display device comprising:
a frame with a cambered top;
a rear cover mounted on a rear of the frame;
a partition plate provided in the frame to partition the frame into an upper chamber and a lower chamber;
a cambered board positioned at a front of the upper chamber;
an optical transmitter positioned in the cambered board to emit a light signal;
an optical sensor mounted in the upper chamber and positioned in alignment with the optical transmitter to receive the light signal from the optical transmitter;
a plurality of first gears positioned on a bottom of the frame, and each first gear being defined with a hole;
a plurality of second gears, each second gear being engagingly received between each adjacent pair of the first gears;
a motor operationably controlled by the optical sensor and positioned in the upper chamber, wherein the motor having an axle extending downwardly; and
a plurality of three-face hollow columns disposed in the lower chamber, wherein each three-face hollow column has a top cover and a bottom cover respectively covering two ends of the column, and
each top cover and bottom cover is respectively formed with a first stub and a second stub, each second stub corresponds to the hole of the first gear, one of the first stubs is connected with the axle of the motor, and the other first stubs are rotatably installed in the partition plate.

2. The advertisement display device as claimed in claim 1, wherein on the rear coverhas a trigger plate having trigger members corresponding to pegs formed on the axle of the motor whereby rotation of the plurality of three-face hollow columns is regulated.
